(19) United States
(12) Patent Application Publication
(10) Pub. No.: US 2026/0244288 A1
(43) Pub. Date: Aug. 20, 2026

(54) WIRING SUBSTRATE, BACKPLANE, AND LIGHT EMITTING DEVICE

(71) Applicants: Hefei BOE Ruisheng Technology Co., Ltd., Hefei, Anhui (CN); BOE Technology Group Co., Ltd., Beijing (CN)

(72) Inventors: Jiawei XU, Beijing (CN); Xintao WU, Beijing (CN); Jie WANG, Beijing (CN); Tingwei HAN, Beijing (CN); Ningyu LUO, Beijing (CN); Wenzhuo TANG, Beijing (CN)

(21) Appl. No.: 18/851,552

(22) PCT Filed: Dec. 29, 2023
(86) PCT No.: PCT/CN2023/143127

§ 371 Date: Sep. 26, 2024

(30) Foreign Application Priority Data
Sep. 19, 2023 (CN) 202311216249.1

(51) Int. Cl. G06F 3/041; G06F 3/044

(52) U.S. Cl. CPC G06F 3/0412; G06F 3/0445; G06F 3/0446; G06F 2203/04107

(57) ABSTRACT

Disclosed are a wiring substrate, a backplane, and a light emitting device, the wiring substrate includes: a base substrate; a plurality of connecting electrode regions in an array on the base substrate; a plurality of touch electrodes; where orthographic projections of the plurality of touch electrodes on the base substrate and orthographic projections of the plurality of connecting electrode regions on the base substrate do not overlap with each other.

### CROSS REFERENCES TO RELATED APPLICATIONS

This application is a national phase entry under 35 U.S. C § 371 of International Application No. PCT/CN2023/143127, filed on Dec. 29, 2023, which claims priority to Chinese Patent Application No. 202311216249.1, filed on Sep. 19, 2023 to the China National Intellectual Property Administration, and entitled “Wiring Substrate, Backplane, and Light Emitting Device”, the entire content of which is incorporated herein by reference.

### TECHNICAL FIELD

The present disclosure relates to the technical field of display, and in particular to a wiring substrate, a backplane and a light emitting device.

### BACKGROUND

Mini/Micro LED (Mini/Micro Light Emitting Diode) is mainly formed by miniaturizing, arranging, and thinning traditional LED chips with the micro manufacturing process technology, and then transferring LED crystal thin films in batches to the driving backplane through massive transfer technology, using physical deposition to manufacture protective layers, and finally completing packaging.

Mini LED backlight is to replace the backlight containing dozens of LED on the side of the display screen with a direct-type backlight containing thousands, tens of thousands or more of Mini LED. Each pixel of Micro LED display can be addressed and individually driven to light up, which can be regarded as a LED self-luminous display without backlight with a pixel spacing of micron. Compared with the LCD technology and OLED technology that have been mass produced, Mini/Micro LED has excellent performance advantages in almost every technical dimension, such as long lifespan, high contrast, high resolution, fast response speed, wider viewing angle effects, rich colors, ultra-high brightness, and lower power consumption.

### SUMMARY

Embodiments of the present disclosure provide a wiring substrate, including:
a base substrate;
a plurality of connecting electrode regions in an array on the base substrate;
a plurality of touch electrodes;
where orthographic projections of the plurality of touch electrodes on the base substrate and orthographic projections of the plurality of connecting electrode regions on the base substrate do not coincide with each other.

In some embodiments, in the above-described wiring substrate provided by embodiments of the present disclosure, some touch electrodes among the plurality of touch electrodes are in a layer where the plurality of connecting electrode regions are located.

In some embodiments, in the above-described wiring substrate provided by embodiments of the present disclosure, the wiring substrate further includes: a plurality of first signal lines in the same layer as the some touch electrodes; where the some touch electrodes are in gaps between adjacent first signal lines.

In some embodiments, in the above-described wiring substrate provided by embodiments of the present disclosure, the wiring substrate further includes: a plurality of second signal lines between the base substrate and the layer where the plurality of connecting electrode regions are located; where remaining touch electrodes other than the some touch electrodes among the plurality of touch electrodes are on a same layer as the plurality of second signal lines, and the remaining touch electrodes are in gaps between adjacent second signal lines.

In some embodiments, in the above-described wiring substrate provided by embodiments of the present disclosure, the wiring substrate further includes: a plurality of data signal lines between the base substrate and the layer where the plurality of connecting electrode regions are located; where remaining touch electrodes other than the some touch electrodes among the plurality of touch electrodes are reused as the plurality of data signal lines.

In some embodiments, in the above-described wiring substrate provided by embodiments of the present disclosure, the wiring substrate further includes: a plurality of second signal lines between the base substrate and the layer where the plurality of connecting electrode regions are located; where remaining touch electrodes other than the some touch electrodes among the plurality of touch electrodes are on a side of the layer where the plurality of connecting electrode regions are located facing away from the base substrate; and orthographic projections of the remaining touch electrodes on the base substrate coincide with orthographic projections of the plurality of second signal lines on the base substrate.

In some embodiments, in the above-described wiring substrate provided by embodiments of the present disclosure, the wiring substrate further includes: a plurality of first signal lines in a layer where the plurality of connecting electrode regions are located, and a plurality of second signal lines between the base substrate and the layer where the plurality of connecting electrode regions are located; some touch electrodes and remaining touch electrodes other than the some touch electrodes among the plurality of touch electrodes are on a side of the layer where the plurality of connecting electrode regions are located facing away from the base substrate, and the some touch electrodes and the remaining touch electrodes are in different layers and intersect with each other; one of two groups of orthographic projections, orthographic projections of the some touch electrodes on the base substrate and orthographic projections of the remaining touch electrodes on the base substrate, coincide with orthographic projections of the plurality of first signal lines on the base substrate, and the other one of the two groups of orthographic projections, the orthographic projections of the some touch electrodes on the base substrate and the orthographic projections of the remaining touch electrodes on the base substrate, coincide with orthographic projections of the plurality of second signal lines on the base substrate.

In some embodiments, in the above-described wiring substrate provided by embodiments of the present disclosure, the plurality of touch electrodes include a plurality of touch driving electrodes and a plurality of touch sensing electrodes; and a layer where the plurality of touch sensing electrodes are located is on a side of a layer where the plurality of touch driving electrodes are located facing away from the base substrate.

In some embodiments, in the above-described wiring substrate provided by embodiments of the present disclosure, at least one of the touch driving electrode and the touch sensing electrode is provided with a grid structure.

In some embodiments, in the above-described wiring substrate provided by embodiments of the present disclosure, a line width of the grid structure ranges from 2 μm to 5 μm, and a line distance of the grid structure ranges from 150 μm to 600 μm.

In some embodiments, in the above-described wiring substrate provided by embodiments of the present disclosure, the base substrate is a transparent substrate.

Based on the same inventive concept, embodiments of the present disclosure provide a backplane including the wiring substrate provided by embodiments of the present disclosure and a plurality of groups of elements, the plurality of groups of elements are electrically connected with the plurality of connecting electrode regions.

Based on the same inventive concept, embodiments of the present disclosure provide a light emitting device including the backplane provided by embodiments of the present disclosure, the group of elements includes at least one light emitting element, the connecting electrode region includes at least one connecting electrode group, and the at least one light emitting element is connected with the at least one connecting electrode group.

### BRIEF DESCRIPTION OF FIGURES

FIG. 1 is a schematic diagram of a structural of the backplane provided by an embodiment of the present disclosure.

FIG. 2 is a cross-sectional view along line A-A′ in FIG. 1.

FIG. 3 is a schematic diagram of a structural of the touch electrode in FIG. 1.

FIG. 4 is a schematic diagram of a structural of the light emitting functional layer in FIG. 1.

FIG. 5A is an enlarged schematic diagram of a structural of Z1 region in FIG. 4.

FIG. 5B is an alternative schematic diagram of the structure shown in FIG. 5A.

FIG. 6 is an enlarged schematic diagram of a structural of Z2 region in FIG. 5B.

FIG. 7 is a cross-sectional view along the line B-B′ in FIG. 6.

FIG. 8 is the working timing diagram of the data signal line in FIG. 1.

FIG. 9 is a schematic diagram of a structural of the wiring substrate provided by an embodiment of the present disclosure.

FIG. 10 is a cross-sectional view along the C-C′ line in FIG. 9.

FIG. 11 is a schematic diagram of a structural of the touch electrode in FIG. 9.

FIG. 12 is another schematic diagram of a structural of the wiring substrate provided by an embodiment of the present disclosure.

FIG. 13 is a cross-sectional view along the D-D′ line in FIG. 11.

FIG. 14 is a schematic diagram of a structural of the touch electrode in FIG. 12.

FIG. 15 is another schematic diagram of a structural of the wiring substrate provided by an embodiment of the present disclosure.

FIG. 16 is a cross-sectional view along the E-E′ line in FIG. 15.

FIG. 17 is a schematic diagram of a structural of the touch electrode in FIG. 15.

FIG. 18 is another schematic diagram of a structural of the wiring substrate provided by an embodiment of the present disclosure.

FIG. 19 is a cross-sectional view along the line F-F′ in FIG. 18.

FIG. 20 is a schematic diagram of a structural of the touch electrode of FIG. 18.

### DETAILED DESCRIPTION

In order to make the purpose, technical solutions and advantages of embodiments of the present disclosure more clear, the technical solutions of embodiments of the present disclosure will be clearly and completely described below in conjunction with the drawings of embodiments of the present disclosure. It should be noted that in the accompanying drawings, the thickness of a layer, a film, a panel, an area, etc., is enlarged for clarity. In the disclosure, an exemplary embodiment is described by referring to a cross-sectional diagram as a schematic diagram of an idealized embodiment. In this way, deviations from the shape of the drawing as a result of, for example, manufacturing techniques and/or tolerances are expected. Thus, embodiments described in the present disclosure should not be construed as being limited to the specific shape of an area as shown in the present disclosure, but rather include deviations in shape caused by, for example, manufacturing. For example, regions illustrated or described as flat may typically have rough and/or non-linear features; sharp corners illustrated may be rounded, etc. Thus, the areas shown in the drawings are schematic in nature, and their dimensions and shapes do not purport to be the exact shape of the areas shown, do not reflect true proportions, and are intended to be illustrative of the present disclosure only. And the same or similar labels throughout represent the same or similar components or components with the same or similar functions. In order to keep the following description of embodiments of the present disclosure clear and concise, the present disclosure omits detailed descriptions of known functions and known components.

Unless otherwise defined, technical or scientific terms used herein shall have their ordinary meaning understood by a person of ordinary skill in the art to which the disclosure belongs. “First”, “second” and similar words used in the description and the claims of the disclosure do not indicate any order, quantity or importance, but are only used to distinguish different components. Words such as “include” or “comprise” mean that the elements or objects appearing before the word include the elements or objects listed after the word and their equivalents, without excluding other elements or objects. The words “connect”, “couple”, etc. are not limited to physical or mechanical connection, but can include electrical connection whether direct or indirect. Words such as “inside”, “outside”, “up”, “down” are only used to express relative positional relationships. When the absolute position of the described object is changed, the relative positional relationship may also be changed accordingly.

In the following description, when an element or layer is referred to as being “on” or “connected with” another element or layer, the element or layer may be directly on or directly connected with the other element or layer, or intervening elements or layers may be present. When an element or layer is referred to as being “arranged on one side of” another element or layer, the element or layer may be directly on one side of the other element or layer, directly connected with the other element or layer, or intervening elements or layers may be present. However, when an element or layer is referred to as being “directly on” or “directly connected with” another element or layer, there are no intervening elements or layers present. The term “and/or” includes any and all combinations of one or more of the associated listed items.

In the process of LCD display, the emitted light from the backlight source will pass through the polarizer and color filter in turn, and there will be a lot of energy loss in this display process. The Mini/Micro LED display adopts a three primary color sub-pixel self-luminous structure. Compared with LCD display, the power consumption of Mini/Micro LED can be reduced by about 10%. Mini/Micro LED uses inorganic materials to emit light with higher luminous efficiency. OLED uses organic materials to emit light. Compared with the two, Mini/Micro LED has lower luminous power consumption than OLED. In addition, unlike OLED, which uses organic materials, Mini/Micro LED uses gallium nitride (GaN) materials in the light emitting portion, which can provide brightness significantly better than OLED. In Mini/Micro LED display products, each Mini/Micro LED is a pixel capable of self-illumination, and a single Mini/Micro LED is at the micron level, so it can achieve very high resolution. In related technologies, the pixel density of Mini/Micro LED displays can be more than 1500 PPI, while the PPI of LCD and OLED screens is about 800 PPI and 400 PPI.

Based on the above advantages, Mini/Micro LED display will become the next generation display after LCD display and OLED display, with broad application prospects. However, the related Mini/Micro LED display products use external touch module to achieve touch function, which has the disadvantages of high cost, low light transmittance, and thick overall product.

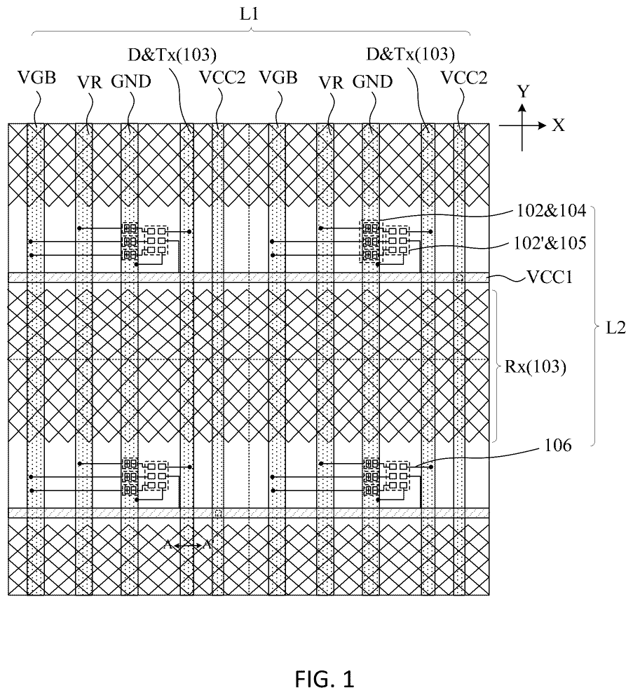

In order to at least solve the above technical problems existing in the related technology, embodiments of the present disclosure provide a wiring substrate, as shown in FIGS. 1 to 4, the wiring substrate includes:
a base substrate 101;
a plurality of connecting electrode regions 102 in an array on the base substrate 101; in some embodiments, the connecting electrode regions 102 are connected with an element group 104 including at least one light emitting element to realize a light emitting display;
a plurality of touch electrodes 103; where orthographic projections of the plurality of touch electrodes 103 on the base substrate 101 and orthographic projections of the plurality of connecting electrode regions 102 on the base substrate 101 do not overlap with each other, so that the pattern of the touch electrodes 103 and the connecting electrode regions 102 do not interfere with each other.

In the above-described wiring substrate provided in embodiments of the present disclosure, the connecting electrode region 102 can be connected with the light emitting element to realize a display function, and the touch electrode 103 can realize a touch control function, thereby realizing a display-touch control integration. Moreover, since the orthographic projections of the touch electrodes 103 on the base substrate 101 and the orthographic projections of the connecting electrode regions 102 on the base substrate 101 do not overlap with each other, therefore, the touch function and the display function do not affect each other. In addition, compared with the solution of realizing the touch control function with an external touch module, the present disclosure realizes the touch control function by integrating the touch electrodes 103 inside the wiring substrate, which results in lower cost, higher transmittance rate, and thinner overall product.

In some embodiments, in the wiring substrate provided in embodiments of the present disclosure, the base substrate 101 may be a transparent substrate that allows visible light to pass through, so as to facilitate application in transparent display fields such as intelligent transportation, intelligent windows, outdoor display, etc. In some embodiments, the transparent substrate may be made of glass, quartz, plastics, polyimide, and the like.

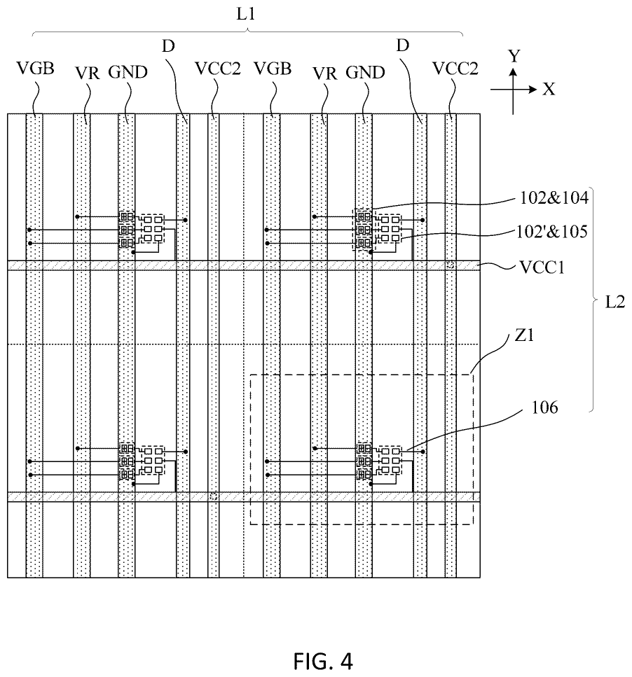

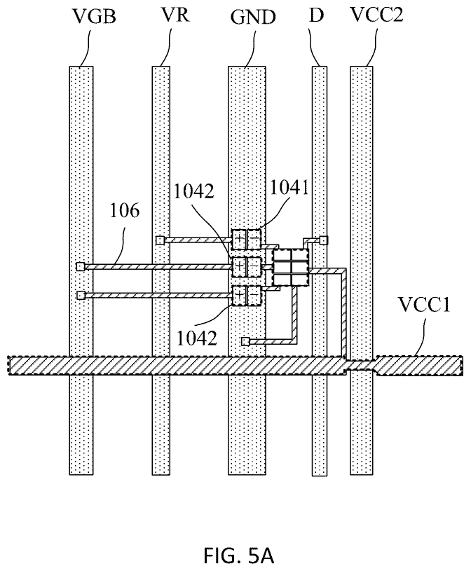

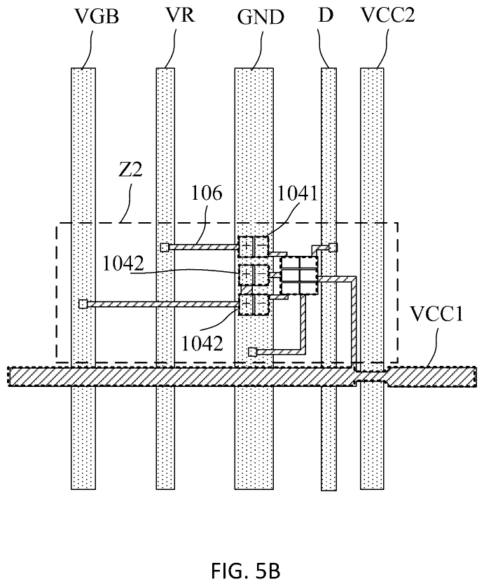

In some embodiments, as shown in FIG. 1, FIG. 4, FIG. 5A to FIG. 5B, and FIG. 6, in order to achieve color display, the element group 104 connected with the connecting electrode region 102 at least includes the first type of light emitting element 1041 and the second type of light emitting element 1042. The first type of light emitting element 1041 and the second type of light emitting element 1042 are configured to emit light of different wavebands. In some embodiments, the emitting light band of the first type of light emitting element 1041 ranges from 615 nm to 650 nm, and the emitting light band of the second type of light emitting element 1042 ranges from 440 nm to 550 nm. For example, the first type of light emitting element 1041 only includes one type light emitting element, which is used to emit red light in the range of 615 nm to 650 nm, and its peak wavelength can be 600 nm. The second type of light emitting element 1042 includes two types of light emitting elements, which are used to emit blue light in the range of 440 nm to 480 nm and emit green light in the range of 495 nm to 550 nm, respectively, and their peak wavelengths can be 450 nm and 530 nm respectively.

The first type of light emitting element 1041 and the second type of light emitting element 1042 can both be inorganic light emitting diodes (LEDs). Here, there is no limit on the type of inorganic light emitting diodes. LEDs with quantum well junction, LED with columnar structure, LED with double hetero-structure, etc. can be used. LEDs can be considered as structures with dimensions reduced to hundreds of micrometers, namely Mini LED or Micro LED, etc. The region of the emitting light region of the LED is preferably less than 1 mm², more preferably less than 10000 μm², further preferably less than 3000 μm², further preferably less than 700 μm², or even less than 200 μm².

Continuing to refer to FIG. 5A, FIG. 5B and FIG. 6, it can be seen that the first type of light emitting element 1041 and the second type of light emitting element 1042 in the element group 104 both include the first electrode “+” and the second electrode “−”. In some embodiments, the first electrode “+” of the first type of light emitting element 1041 is connected with the corresponding first fixed potential signal line VR, and the first electrode “+” of the second type of light emitting element 1042 is connected with the corresponding first fixed potential signal line VGB, the second electrode “−” of the first type of light emitting element 1041 and the second type of light emitting element 1042 are connected with the micro driving chip 105, and the micro driving chip 105 is also connected with the common potential signal line GND, the data signal line D and the first power signal line VCC1 respectively.

In some embodiments, the first power signal line VCC1 can transmit both DC signals and digital signals. The first power signal line VCC1 is used to supply power to the connected micro driving chip 105. The data signal line D transmits a digital signal, and the micro driving chip 105 receives the digital signal transmitted by the data signal line D to determine the light emitting time of each light emitting element in the element group 104, thereby controlling the brightness of each light emitting element. The set potential signal is transmitted in the common potential signal line GND to provide constant potential. The first electrode “+” of the first type of light emitting element 1041 is connected with the first fixed potential signal line VR, the second electrode “−” of the first type of light emitting element 1041 is connected with the common potential signal line GND through the micro driving chip 105, the first fixed potential signal line VR is used to provide the first fixed potential, and the micro driving chip 105 controls the conduction and non-conduction between the first type of light emitting element 1041 and the common potential signal line GND. Thus, the light emission time of the first type of light emitting element 1041 is controlled by controlling the conduction time of the first type of light emitting element 1041. Similarly, the first electrode “+” of the second type of light emitting element 1042 is connected with the first fixed potential signal line VGB, the second electrode “−” of the second type of light emitting element 1042 is connected with the common potential signal line GND through the micro driving chip 105, the first fixed potential signal line VGB is used to provide the second fixed potential, and the micro driving chip 105 controls the conduction and non-conduction between the second type of light emitting element 1042 and the common potential signal line GND. Thus, the emission time of the second type of light-emitting element 1042 can be controlled by controlling the conduction time of the second type of light-emitting element 1042. When the second type of light emitting element 1042 includes two light emitting elements, as shown in FIG. 5A, the first electrode “+” of the two light emitting elements can be respectively connected with the second fixed potential line 32, or, as shown in FIG. 5B, the first electrode “+” of the two light emitting elements can be connected and then connected with the second fixed potential line 32. The second electrodes “−” of the two light emitting elements are respectively connected with the micro driving chip 105, as shown in FIGS. 5A and 5B.

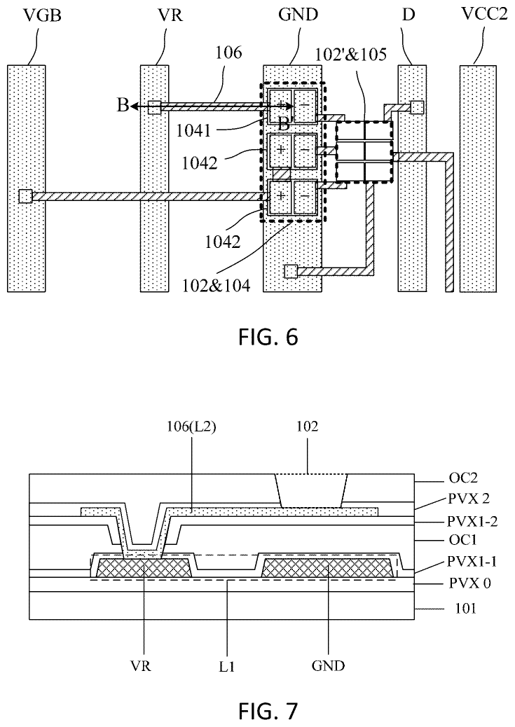

In addition, as shown in FIG. 4, since the wiring substrate usually forms a bonding region at the edge of at least one side in the first direction Y, the embodiment of the present disclosure is provided with a second power signal line VCC2 to connect the first power signal line VCC1, and one second power signal line VCC2 can connect one first power signal line VCC1, thus connecting the corresponding first power signal line VCC1 to the bonding region. In some embodiments, as shown in FIG. 7, the wiring substrate may include a first conductive layer L1 and a second conductive layer L2. In some embodiments, the second power supply signal line VCC2 is arranged in the first conductive layer L1, and the first power supply signal line VCC1 is arranged in the second conductive layer L2, and the two are electrically connected through the via-hole passing through the insulating layer (such as the stacked first inorganic insulating layer PVX1-1, the first organic insulating layer OC1, and the second inorganic insulating layer PVX1-2).

In some embodiments, as shown in FIG. 4, FIG. 5A, FIG. 5B, FIG. 6 and FIG. 7, the first fixed potential signal line VR, the second fixed potential signal line VGB, the common potential signal line GND and the data signal line D can also be arranged in the first conductive layer L1 where the second power signal line VCC2 is located. In the second conductive layer L2 where the first power signal line VCC1 is located, multiple types of connecting lines 106 can also be arranged. These connecting lines 106 can be used to connect the first fixed potential signal line VR with the first type of light emitting element 1041, the second fixed potential signal line VGB with the second type of light emitting element 1042, the first type of light emitting element 1041 with the micro driving chip 105, the second type of light emitting element 1042 with the micro driving chip 105, the micro driving chip 105 with the data signal line D, the micro driving chip 105 with the first power signal line VCC1, etc. In some embodiments, the connecting line 106 for connecting the micro driving chip 105 and the first power signal line VCC1 is integrated with the first power signal line VCC1.

In embodiments of the present disclosure, one first power signal line VCC1 is correspondingly connected with one row of micro driving chips 105 arranged along the second direction X, while one second power signal line VCC2 is correspondingly connected with one first power signal line VCC1. FIG. 1 only shows the case that the number of columns arranged along the first direction Y of the micro driving chips 105 is the same as the number of rows arranged along the second direction X of the micro driving chips 105. In some embodiments, the number of columns arranged along the first direction Y of the micro driving chips 105 and the number of rows arranged along the second direction X of the micro driving chips 105may be different. For example, when the number of columns arranged along the first direction Y of the micro driver chip 105 is greater than the number of rows arranged along the second direction X of the micro driver chip 105, it is only necessary to set the same number of second power signal lines VCC2 as the number of rows of the micro driver chip 105. The second power signal line VCC2 is electrically connected with the corresponding first power signal line VCC1 through the via-holes in the insulation layer. When the layout of the micro driving chip 105 and the element group 104 changes, the via-holes connection method of the first power signal line VCC1 and the second power signal line VCC2 can also be adaptively adjusted, and the embodiments of the disclosure is not limited here.

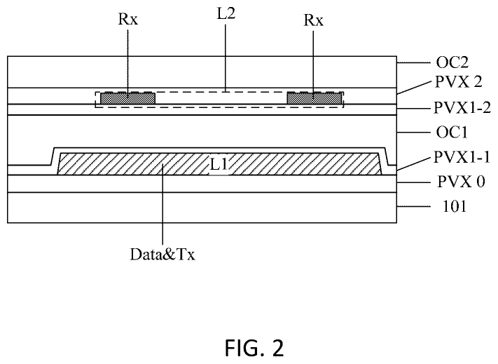

In addition, as shown in FIG. 2 and FIG. 7, the wiring substrate can also include a buffer layer (PVX0) between the first conductive layer L1 and the base substrate 101. The buffer layer (PVX0) can use insulating materials such as silicon nitride to offset the deformation of the base substrate 101 that may be caused in the process of preparing the signal line in the first conductive layer L1. When signal lines are arranged on both sides of the base substrate 101, the stresses between the corresponding signal lines cancel each other, which will not cause the deformation of the base substrate 101, and the buffer layer (PVX0) may not be arranged.

As shown in FIG. 7, the wiring substrate can also include a protective layer (such as the stacked third inorganic insulating layer PVX2 and the second organic insulating layer OC2) arranged on the side of the second conductive layer L2 facing away from the base substrate 101. The third inorganic insulating layer can be made of silicon nitride and other materials, and directly cover the surface of the second conductive layer L2 facing away from the base substrate 101 to ensure insulation protection of the signal line of the second conductive layer L2. In some embodiments, the protective layer has via-holes that expose the connecting electrode region 102 and the pad region 102′ bound to the micro driving chip 105.

It should be understood that the touch electrode 103 of the present disclosure can be a self-capacitive touch electrode or a mutual capacitive touch electrode. The present disclosure takes the touch electrode 103 as a mutual capacitive touch electrode as an example to illustrate. By way of example, when the touch electrode 103 is a mutual capacitive touch electrode, the multiple touch electrodes 103 can include a plurality of touch driving electrodes Tx and a plurality of touch sensing electrodes Rx. In some embodiments, in order to improve touch sensitivity, the layer where the multiple touch sensing electrodes Rx are located can be arranged on the side of the layer where the multiple touch driving electrodes Tx are located facing away from the base substrate 101.

In some embodiments, in the above wiring substrate provided by embodiments of the present disclosure, some touch electrodes 103 among the plurality of touch electrodes can be arranged on the same layer with a plurality of connecting electrode regions 102. For example, as shown in FIGS. 1 to 3, the some touch electrodes 103 (such as the touch sensing electrode Rx) is arranged in the second conductive layer L2 where the multiple connecting electrode regions 102 are located. In this way, the second conductive layer L2 where multiple connecting electrode regions 102 are located can be used to form a pattern of the some touch electrodes 103 (such as the touch sensing electrode Rx), so as to minimize the new film layer, improve the transmittance, and facilitate the lightweight design.

As can be seen from FIG. 1, a plurality of first signal lines (such as the first power signal line VCC1) are arranged on the second conductive layer L2 where the multiple connecting electrode regions 102 are located. In some embodiments, to avoid short circuit between the part of touch electrodes 103 (such as touch sensing electrode Rx) and the first signal line (such as the first power signal line VCC1), the part of touch electrodes 103 (such as touch sensing electrode Rx) can be arranged in the gap between the first signal line (such as the first power signal line VCC1). In the embodiments shown in FIGS. 1 to 3, each touch sensing electrode Rx is in a strip shape, and each touch sensing electrode Rx extends along the second direction X, and adjacent touch sensing electrodes Rx are spaced along the first direction Y. In some embodiments, the touch sensing electrode Rx is made of copper. Generally, the larger the area of the touch sensing electrode Rx is, the better the touch sensitivity is. Therefore, the present disclosure can maximize the size of the touch sensing electrode Rx in the first direction Y while ensuring that the some touch electrodes 103 (such as the touch sensing electrode Rx) is not shorted to the first signal line (such as the first power signal line VCC1).

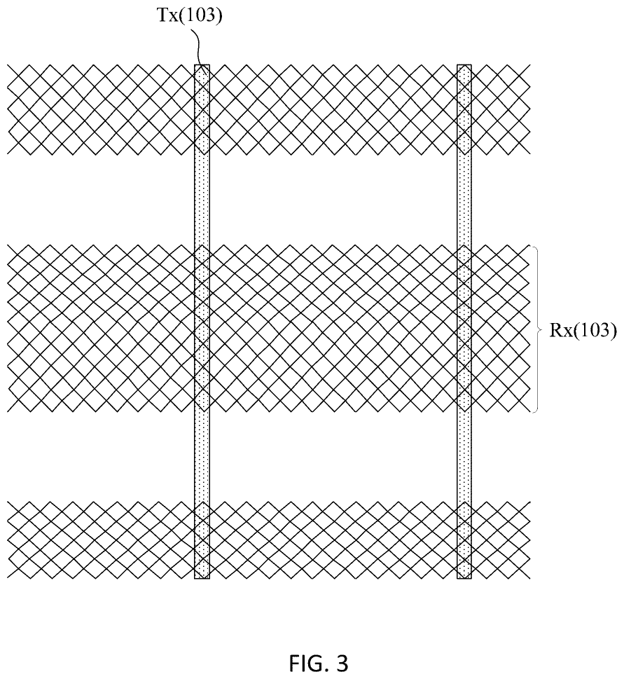

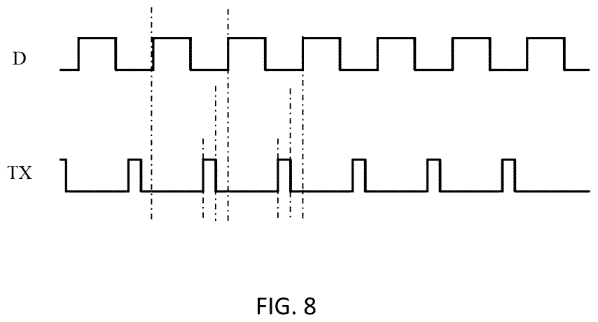

A plurality of data signal lines D are also shown in FIG. 1. It can be seen from the above that the data signal line D is located in the first conductive layer L1 between the base substrate 101 and the second conductive layer L2 where the multiple connecting electrode regions 102 are located. In the present disclosure, remaining touch electrodes other than the some touch electrodes among the plurality of touch electrodes (such as touch driving electrode Tx) can be reused as the plurality of data signal lines, so as to avoid additional film layers, which is conducive to lightweight design, and the remaining touch electrodes (such as touch driving electrode Tx) will not have any impact on the transmittance. As can be seen from FIG. 3, each touch driving electrode Tx is in a strip shape, and each touch driving electrode Tx extends along the first direction Y, and adjacent touch driving electrodes Tx are spaced along the second direction X. In some embodiments, the touch driving electrode Tx is made of copper. In some embodiments, the timing shown in FIG. 8 can be used to drive the wiring substrate in a time-sharing manner. In some embodiments, display is performed when the D signal provided by data signal line D is at a high level, and touch is performed when the TX signal provided by data signal line D is at a high level. Alternatively, display can be performed when the D signal provided by data signal line D is at a low level, and touch can be performed when the TX signal provided by data signal line D is at a low level. In the example of FIG. 1, the touch driving electrodes Tx are reused as the multiple data signal lines D, and the touch sensing electrode Rx is arranged on the same layer as the first power signal line VCC1, and the touch sensing electrodes Rx are arranged in the gap between the first power signal lines VCC1. Compared with the wiring substrate without touch function in related technologies, there is no new layer added, and the transmittance reduction is within 5%.

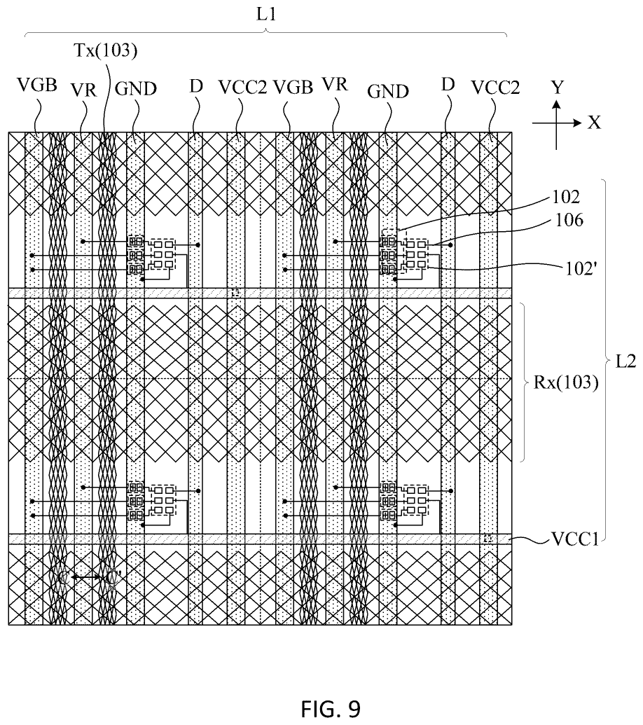

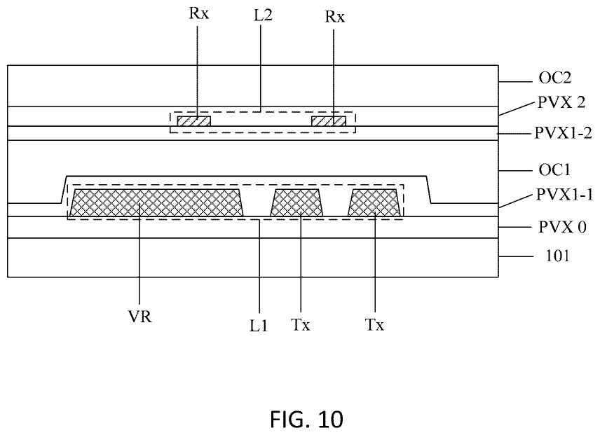

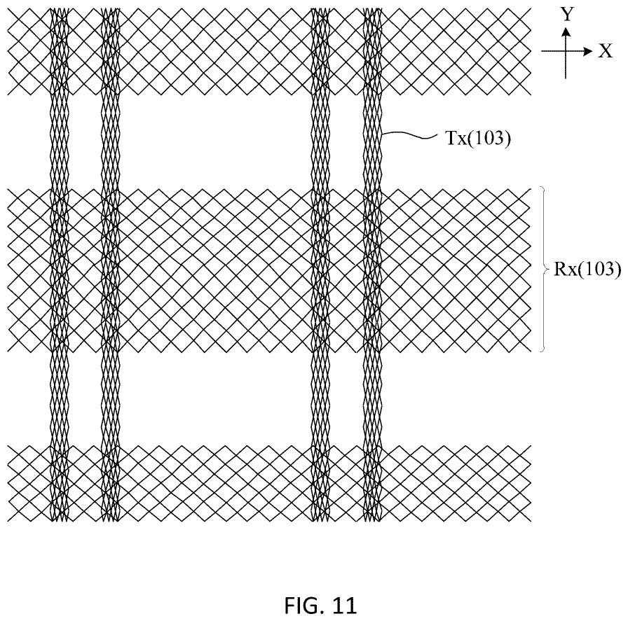

In some embodiments, as shown in FIGS. 9 to 11, when the some touch electrodes 103 (such as the touch sensing electrode Rx) is arranged in the second conductive layer L2 where the connecting electrode region 102 is located, the remaining touch electrodes (such as the touch driving electrode Tx) can also be arranged in the first conductive layer L1 between the base substrate 101 and the second conductive layer L2 where the multiple connecting electrode regions 102 are located, so that it is unnecessary to add a new conductive layer (such as a metal layer) to make the touch electrode 103. In some embodiments, each touch sensing electrode Rx is in a strip shape, and each touch sensing electrode Rx extends along the second direction X, and adjacent touch sensing electrodes Rx are spaced along the first direction Y. Each touch driving electrode Tx is in a strip shape, and each touch driving electrode Tx extends along the first direction Y, and adjacent touch driving electrodes Tx are spaced along the second direction X. The materials of touch driving electrode Tx and touch sensing electrode Rx can include copper, etc. However, the first conductive layer L1 where multiple connecting electrode regions 102 are located is provided with multiple second signal lines (such as the first fixed potential signal line VR, the second fixed potential signal line VGB, the common potential signal line GND, the data signal line D, and the second power signal line VCC2). Therefore, in order to avoid short circuiting between the remaining touch electrodes (such as touch driving electrode Tx) arranged on the same layer and the second signal line (such as the first fixed potential signal line VR, the second fixed potential signal line VGB, the common potential signal line GND, the data signal line D, the second power signal line VCC2), and the remaining touch electrodes (such as the touch driving electrode Tx) can be set in the gap between the second signal lines (such as first fixed potential signal line VR, second fixed potential signal line VGB, common potential signal line GND, data signal line D, second power signal line VCC2). It is set at the gap of the second signal line (such as the first fixed potential signal line VR, the second fixed potential signal line VGB, the common potential signal line GND, the data signal line D, and the second power signal line VCC2). This scheme has an impact range of 5% to 10% on transmittance.

In some embodiments, in order to avoid the connection between the connecting electrode region 102 and the pad region 102′, and to avoid the signal interference of the pulse signal of the data signal line D on the remaining touch electrodes (such as the touch driving electrode Tx), as shown in FIG. 9, the remaining touch electrodes (such as the touch driving electrode Tx) can be arranged in the gap between the first fixed potential signal line VR and the common potential signal line GND, and/or, the remaining touch electrodes (such as touch driving electrode Tx) can be arranged in the gap between the second fixed potential signal line VGB and the common potential signal line GND.

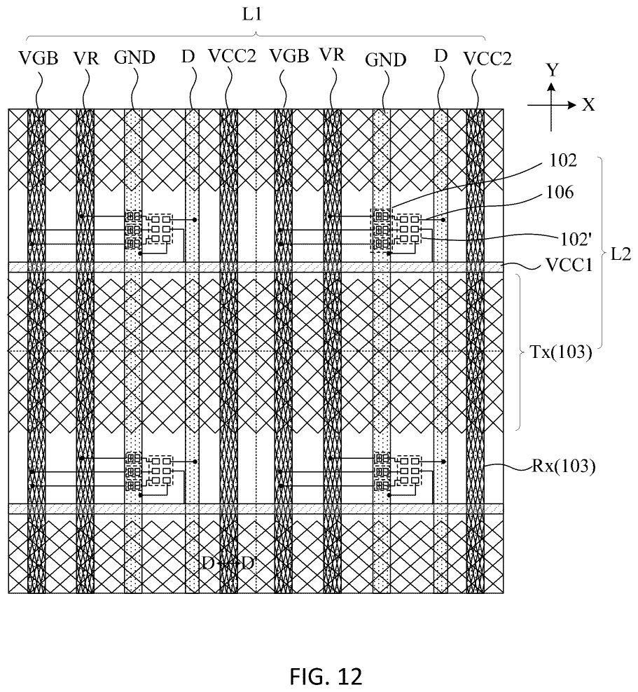

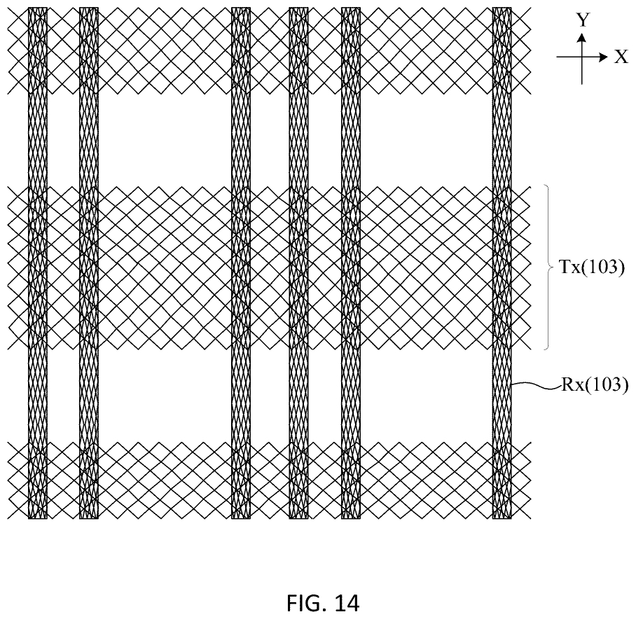

In some embodiments, as shown in FIGS. 12 to 14, the touch driving electrode Tx can also be used as some touch electrodes 103 among the plurality of touch electrodes and arranged on the same layer as the first power signal line VCC1 (for example, they are arranged on the second conductive layer L2). In order to avoid the short circuit between the touch driving electrode Tx and the first power signal line VCC1, the touch driving electrode Tx can be arranged in the gap of the first power signal line VCC1. As can be seen from FIG. 14, each touch driving electrode Tx is in a strip shape, and each touch driving electrode Tx extends along the second direction X, and adjacent touch driving electrodes Tx are spaced along the first direction Y. In some embodiments, the material of touch driving electrode Tx includes copper, etc. Generally, the larger the area of the touch driving electrode Tx is, the better the touch sensitivity is. Therefore, the present disclosure can maximize the size of the touch driving electrode Tx in the first direction Y under the condition that the touch driving electrode Tx is not shorted to the first power signal line VCC1.

In FIGS. 12 to 14, the touch sensitive electrodes Rx, as the remaining touch electrodes 103, are arranged on the side of the second conductive layer L2 where the first power signal line VCC1 is located facing away from the base substrate 101, that is, the layer where the touch sensitive electrode Rx is located is a new added film layer. In some embodiments, in order to avoid the impact of the touch sensing electrode Rx on the transmittance, the orthographic projection of the touch sensing electrode Rx on the base substrate 101 can be overlapped with the orthographic projection of each second signal line (such as the first fixed potential signal line VR, the second fixed potential signal line VGB, and the second power supply signal line VCC2) on the base substrate 101. As can be seen from FIG. 14, each touch sensing electrode Rx is in a strip shape, and each touch sensing electrode Rx extends along the first direction Y, and adjacent touch sensing electrodes Rx are spaced along the second direction X. In some embodiments, the material of the touch sensing electrode Rx includes copper and the like. It should be understood that, as shown in FIG. 12, in order to avoid the impact of the touch sensing electrode Rx on the bonding of light emitting elements in the connecting electrode region 102 and the bonding of micro driving chip 105 in the pad region 102′, the touch sensing electrode Rx avoids the common potential signal line GND overlapped with the connecting electrode region 102 and the data signal line D near the pad region 102′. In the scheme shown in FIG. 12 to FIG. 14, only the touch driving electrode Tx is shielded, and the transmittance influence amplitude is less than 5%.

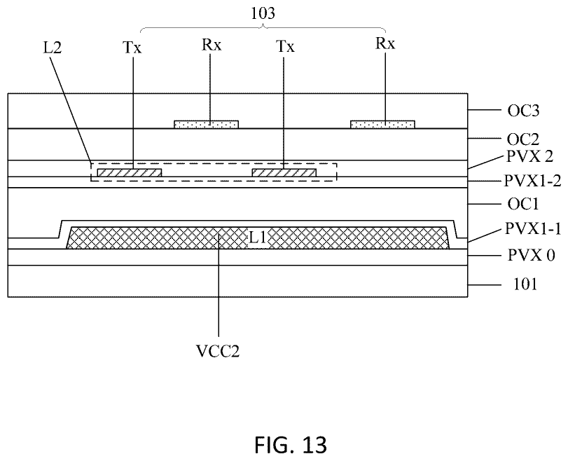

In some embodiments, in order to avoid short circuit between the second conductive layer L2 where the first power signal line VCC1 is located and the new added film layer of touch sensing electrode Rx, as shown in FIG. 13, an insulating layer (such as OC2) is arranged between them. In some embodiments, as shown in FIG. 13, an insulating layer (such as OC3) is also provided on the side of the newly added film layer of the touch sensing electrode Rx facing away from the base substrate 101 to achieve insulation protection of the touch sensing electrode Rx.

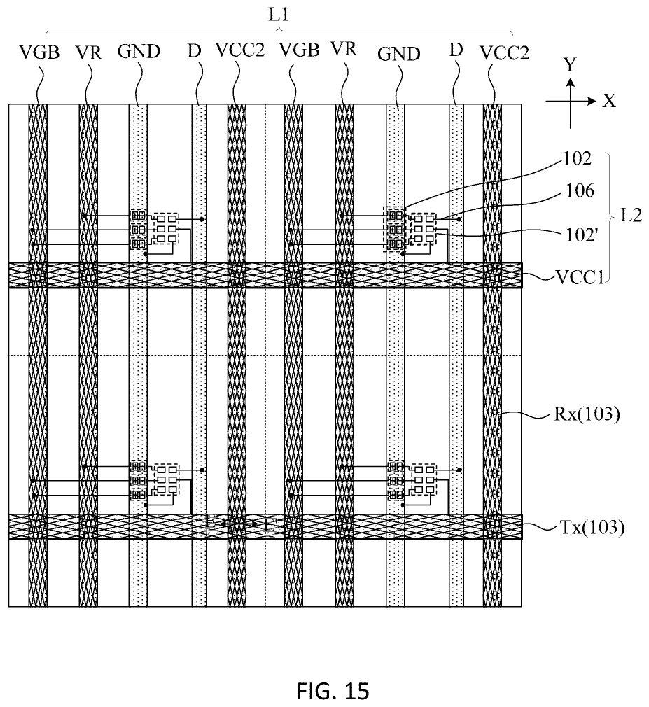

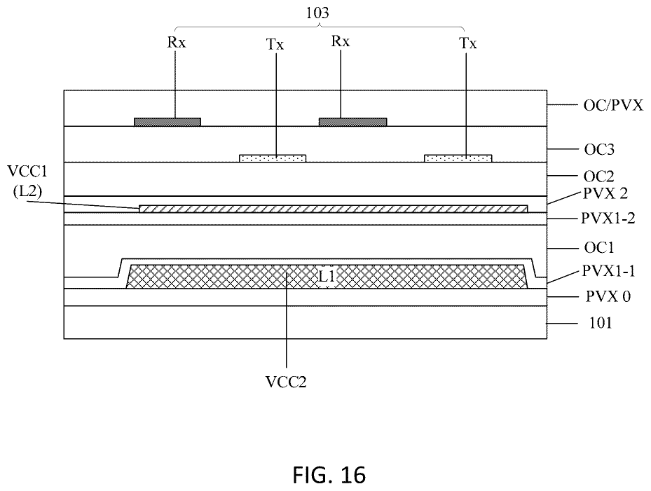

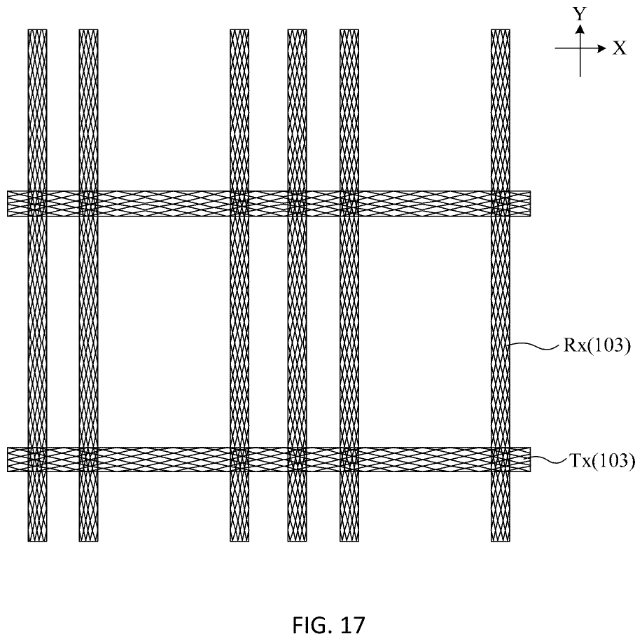

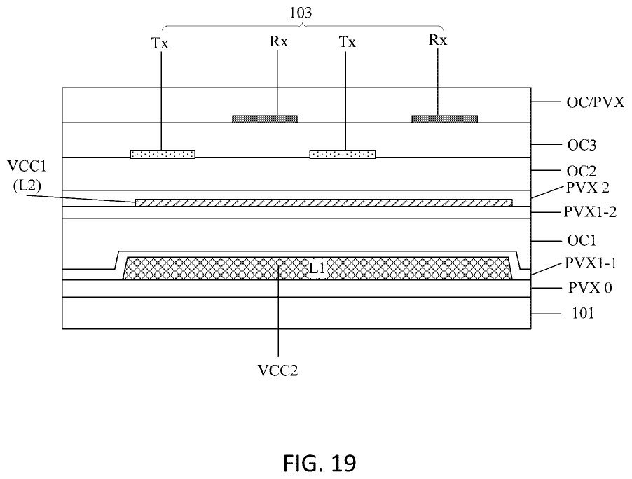

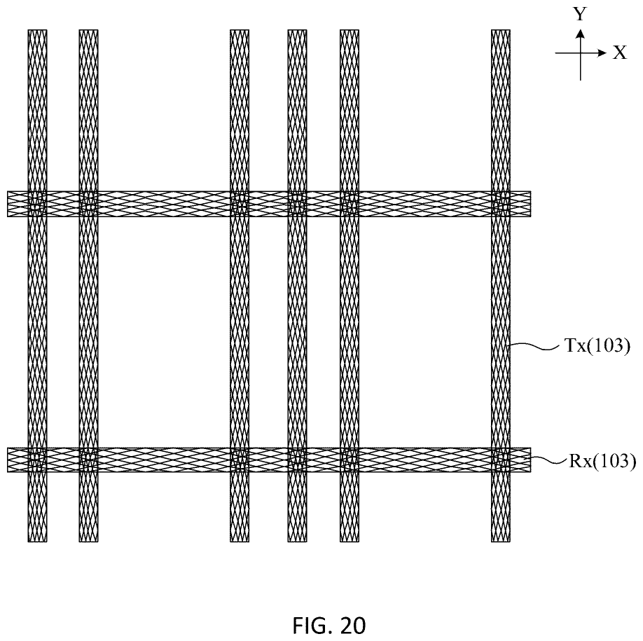

In some embodiments, as shown in FIGS. 15 to 20, the layer where the touch driving electrode Tx is located and the layer where the touch sensing electrode Rx is located can also be arranged on the side of the second conductive layer L2 where the multiple connecting electrode regions 102 are located facing away from the base substrate 101, that is, two new conductive layers can be added to make the touch driving electrode Tx and the touch sensing electrode Rx respectively.

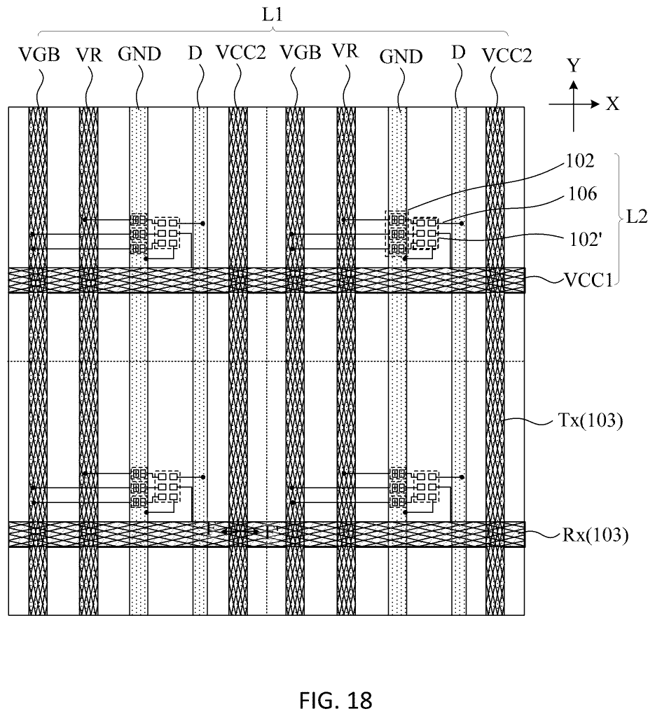

In some embodiments, in order to avoid the influence of touch driving electrode Tx and touch sensing electrode Rx on transmittance, and to avoid affecting the bonding of light emitting elements in the connecting electrode region 102, and the bonding of micro driving chip 105 in the pad region 102′, in FIGS. 15 to 17, the orthographic projections of the touch sensing electrodes Rx on the base substrate 101 coincide with the orthographic projections of the second signal lines, such as the first fixed potential signal line VR, the second fixed potential signal line VGB, the second power signal line VCC2, on the base substrate 101. The orthographic projections of the touch driving electrodes Tx on the base substrate 101 coincide with the orthographic projections of the first power signal lines VCC1 on the base substrate 101. For example, each touch sensing electrode Rx is in a strip shape, and each touch sensing electrode Rx extends along the first direction Y, adjacent touch sensing electrodes Rx are spaced along the second direction X; each touch driving electrode Tx is in a strip shape, and each touch driving electrode Tx extends along the second direction X, and adjacent touch driving electrodes Tx are spaced along the first direction Y. The materials of touch driving electrode Tx and touch sensing electrode Rx can include copper, etc. As shown in FIGS. 18 to 20, the orthographic projections of the touch driving electrodes Tx on the base substrate 101 coincide with the orthographic projections of the second signal lines, such as the first fixed potential signal line VR, the second fixed potential signal line VGB, the second power signal line VCC2, on the base substrate 101. The orthographic projections of the touch sensing electrodes Rx on the base substrate 101 coincide with the orthographic projections of the first power signal lines VCC1 on the base substrate 101. For example, each touch driving electrode Tx is in a strip shape, and each touch driving electrode Tx extends in the first direction Y, and adjacent touch driving electrodes Tx are spaced along the second direction X. Each touch sensing electrode Rx is in a strip shape, and each touch sensing electrode Rx extends along the second direction X, and adjacent touch sensing electrodes Rx are spaced along the first direction Y. The materials of touch driving electrode Tx and touch sensing electrode Rx can include copper, etc.

It should be noted that in the embodiments provided in this disclosure, due to limitations in process conditions or other factors such as measurement, “overlap” may occur exactly, or there may be some deviation (such as a deviation of ±2 μm). Therefore, as long as the “overlap” relationship between relevant features meets the error tolerance, it belongs to the protection scope of this disclosure.

In some embodiments, at least one of the touch driving electrode Tx and the touch sensing electrode Rx can be arranged as a grid structure in order to reduce the impact on the transmittance. In some embodiments, in order to reduce the line break probability, the line width of the grid structure ranges from 2 μm to 5 μm, such as 2 μm, 3 μm, 4 μm, 5 μm, and so on. The line distance ranges from 150 μm to 600 μm, such as 150 μm, 200 μm, 250 μm, 300 μm, 350 μm, 400 μm, 450 μm, 500 μm, 550 μm, 600 μm, etc.

In some embodiments, the wiring substrate provided by the present disclosure can be applied to the transparent display field. In FIG. 1, FIG. 4, FIG. 9, FIG. 12, FIG. 15 and FIG. 18, using dashed lines to separate 2*2 pixel areas, in the absence of touch electrode 103, within one pixel area, the wiring (such as first fixed potential signal line VR, second fixed potential signal line VGB, common potential signal line GND, data signal line D, first power signal line VCC1, second power signal line VCC2), connecting line 106, connecting electrode region 102, and pad region 102′ are light tight regions, and the rest are transparent regions. The region ratio of the light tight region to the transparent region ranges from 25:75 to 35:65 (for example, 30:70). In this disclosure, since the touch electrode 103 adopts a metal grid structure, the light transmittance of the region where the single-layer touch electrode 103 is located is in the range of 92% to 98% (for example, 95%). Preferably, one of the touch electrodes 103 (such as the touch driving electrode Tx) can be reused as a certain wiring (such as the data signal line D), or the orthographic projection of at least one of the touch electrodes 103 (such as the touch driving electrode Tx and/or the touch sensing electrode Rx) coincides with the wiring (such as the first fixed potential signal line VR, the second fixed potential signal line VGB, the first power signal line VCC1, the second power signal line VCC2), which can more ensure that the entire wiring substrate has a good light transmittance and can achieve a display effect with high transparency.

Based on the same inventive concept, embodiments of the present disclosure also provide a backplane, as shown in FIG. 1, the backplane includes the above-described wiring substrate provided in embodiments of the present disclosure and a plurality of groups of elements 104, the plurality of groups of elements 104 are electrically connected with a plurality of connecting electrode regions 102. Since the problem-solving principle of the backplane is similar to the problem-solving principle of the above-described wiring substrate, the implementation of the backplane can be referred to the above-described wiring substrate, and the repetitions will not be repeated.

Based on the same inventive concept, embodiments of the present disclosure also provide a light emitting device including the above-mentioned backplane provided by embodiments of the present disclosure, the group of elements includes at least one light emitting element, the connecting electrode region includes at least one connecting electrode group. In some embodiments, one light emitting element is connected with one connecting electrode group. Since the problem-solving principle of the light emitting device is similar to the problem-solving principle of the above-described wiring substrate, the implementation of the light emitting device can be seen in the above-described embodiments of the wiring substrate, and repetitions will not be repeated.

In some embodiments, the light emitting device can be: projector, 3D printer, virtual reality device, mobile phone, tablet computer, television, display, notebook computer, digital photo frame, navigator, smart watch, fitness wristband, personal digital assistant and any other product or component with display function. The display device includes but is not limited to: radio frequency unit, network module, audio output & input unit, sensor, display unit, user input unit, interface unit, control chip and other components. In some embodiments, the control chip is a central processor, a digital signal processor, a system on chip (SoC), etc. For example, the control chip can also include memory, power module, etc., and realize power supply and signal input and output functions through additional wires, signal wires, etc. For example, the control chip may also include hardware circuits, computer executable codes, etc. Hardware circuits can include conventional Very Large-Scale Integration VLSI circuits or gate arrays, as well as existing semiconductors such as logic chips and transistors or other discrete components. The hardware circuit can also include field programmable gate array, programmable array logic, programmable logic device, etc. In addition, those skilled in the art can understand that the above structure does not constitute the definition of the above display device provided by embodiments of the present disclosure. In other words, the above display device provided by embodiments of the present disclosure can include more or less of the above components, or combine some components, or have different component arrangements.

Although the present disclosure describes preferred embodiments, it should be understood that a person skilled in the art may make various modifications and variations to the embodiments of the present disclosure without departing from the spirit and scope of the embodiments of the present disclosure. Thus, if these modifications and variations of the embodiments of the present disclosure fall within the scope of the claims of the present disclosure and their technical equivalents, the present disclosure is intended to encompass such modifications and variations.

1. A wiring substrate, comprising:
a base substrate;
a plurality of connecting electrode regions in an array on the base substrate;
a plurality of touch electrodes;
wherein orthographic projections of the plurality of touch electrodes on the base substrate and orthographic projections of the plurality of connecting electrode regions on the base substrate do not overlap with each other.

2. The wiring substrate according to claim 1, wherein some touch electrodes among the plurality of touch electrodes are in a layer where the plurality of connecting electrode regions are located.

3. The wiring substrate according to claim 2, further comprising:
a plurality of first signal lines in the same layer as the some touch electrodes;
wherein the some touch electrodes are in gaps between adjacent first signal lines.

4. The wiring substrate according to claim further comprising:
a plurality of second signal lines between the base substrate and the layer where the plurality of connecting electrode regions are located;
wherein remaining touch electrodes other than the some touch electrodes among the plurality of touch electrodes are on a same layer as the plurality of second signal lines, and the remaining touch electrodes are in gaps between adjacent second signal lines.

5. The wiring substrate according to claim 2, further comprising:
a plurality of data signal lines between the base substrate and the layer where the plurality of connecting electrode regions are located;
wherein remaining touch electrodes other than the some touch electrodes among the plurality of touch electrodes are reused as the plurality of data signal lines.

6. The wiring substrate according to claim 2, further comprising:
a plurality of second signal lines between the base substrate and the layer where the plurality of connecting electrode regions are located;
wherein remaining touch electrodes other than the some touch electrodes among the plurality of touch electrodes are on a side of the layer where the plurality of connecting electrode regions are located facing away from the base substrate; and
orthographic projections of the remaining touch electrodes on the base substrate coincide with orthographic projections of the plurality of second signal lines on the base substrate.

7. The wiring substrate according to claim 1, further comprising:
a plurality of first signal lines in a layer where the plurality of connecting electrode regions are located, and a plurality of second signal lines between the base substrate and the layer where the plurality of connecting electrode regions are located;
wherein some touch electrodes and remaining touch electrodes other than the some touch electrodes among the plurality of touch electrodes are on a side of the layer where the plurality of connecting electrode regions are located facing away from the base substrate, and the some touch electrodes and the remaining touch electrodes are in different layers and intersect with each other;
one of two groups of orthographic projections, orthographic projections of the some touch electrodes on the base substrate and orthographic projections of the remaining touch electrodes on the base substrate, coincide with orthographic projections of the plurality of first signal lines on the base substrate, and
the other one of the two groups of orthographic projections, the orthographic projections of the some touch electrodes on the base substrate and the orthographic projections of the remaining touch electrodes on the base substrate, coincide with orthographic projections of the plurality of second signal lines on the base substrate.

8. The wiring substrate according to claim 1, wherein the plurality of touch electrodes comprise a plurality of touch driving electrodes and a plurality of touch sensing electrodes; and
a layer where the plurality of touch sensing electrodes are located is on a side of a layer where the plurality of touch driving electrodes are located facing away from the base substrate.

9. The wiring substrate according to claim 8, wherein at least one of the touch driving electrode and the touch sensing electrode is provided with a grid structure.

10. The wiring substrate according to claim 9, wherein a line width of the grid structure ranges from 2 μm to 5 μm, and a line distance of the grid structure ranges from 150 μm to 600 μm.

11. The wiring substrate according to claim 1, wherein the base substrate is a transparent substrate.

12. A backplane, comprising the wiring substrate according to claim 1 and a plurality of groups of elements;
wherein the plurality of groups of elements are electrically connected with the plurality of connecting electrode regions.

13. A light emitting device, comprising the backplane according to claim 12;
wherein the group of elements comprises at least one light emitting element, the connecting electrode region comprises at least one connecting electrode group, and the at least one light emitting element is connected with the at least one connecting electrode group.

14. The backplane according to claim 12, wherein some touch electrodes among the plurality of touch electrodes are in a layer where the plurality of connecting electrode regions are located.

15. The backplane according to claim 14, wherein the wiring substrate further comprises:
a plurality of first signal lines in the same layer as the some touch electrodes;
the some touch electrodes are in gaps between adjacent first signal lines.

16. The backplane according to claim 14, wherein the wiring substrate further comprises:
a plurality of second signal lines between the base substrate and the layer where the plurality of connecting electrode regions are located;
remaining touch electrodes other than the some touch electrodes among the plurality of touch electrodes are on a same layer as the plurality of second signal lines, and the remaining touch electrodes are in gaps between adjacent second signal lines.

17. The backplane according to claim 14, wherein the wiring substrate further comprises:
a plurality of data signal lines between the base substrate and the layer where the plurality of connecting electrode regions are located;
remaining touch electrodes other than the some touch electrodes among the plurality of touch electrodes are reused as the plurality of data signal lines.

18. The backplane according to claim 14, wherein the wiring substrate further comprises:
a plurality of second signal lines between the base substrate and the layer where the plurality of connecting electrode regions are located;
remaining touch electrodes other than the some touch electrodes among the plurality of touch electrodes are on a side of the layer where the plurality of connecting electrode regions are located facing away from the base substrate; and
orthographic projections of the remaining touch electrodes on the base substrate coincide with orthographic projections of the plurality of second signal lines on the base substrate.

19. The backplane according to claim 12, wherein the wiring substrate further comprises:
a plurality of first signal lines in a layer where the plurality of connecting electrode regions are located, and a plurality of second signal lines between the base substrate and the layer where the plurality of connecting electrode regions are located;
some touch electrodes and remaining touch electrodes other than the some touch electrodes among the plurality of touch electrodes are on a side of the layer where the plurality of connecting electrode regions are located facing away from the base substrate, and the some touch electrodes and the remaining touch electrodes are in different layers and intersect with each other;
one of two groups of orthographic projections, orthographic projections of the some touch electrodes on the base substrate and orthographic projections of the remaining touch electrodes on the base substrate, coincide with orthographic projections of the plurality of first signal lines on the base substrate, and
the other one of the two groups of orthographic projections, the orthographic projections of the some touch electrodes on the base substrate and the orthographic projections of the remaining touch electrodes on the base substrate, coincide with orthographic projections of the plurality of second signal lines on the base substrate.

20. The backplane according to claim 12, wherein the plurality of touch electrodes comprise a plurality of touch driving electrodes and a plurality of touch sensing electrodes; and
a layer where the plurality of touch sensing electrodes are located is on a side of a layer where the plurality of touch driving electrodes are located facing away from the base substrate.
